(19) United States
(12) Patent Application Publication
(10) Pub. No.: US 2015/0028819 A1
(43) Pub. Date: Jan. 29, 2015

(54) METHODS FOR CHARGING A RECHARGEABLE BATTERY

(71) Applicant: Leadtrend Technology Corporation, Hsinchu (TW)

(72) Inventors: Yeu Torng Yau, Hsinchu (TW); Tsung Liang Hung, Hsinchu (TW)

(21) Appl. No.: 14/337,167

(22) Filed: Jul. 21, 2014

(30) Foreign Application Priority Data
Jul. 29, 2013 (TW) 102127028

(51) Int. Cl. H02J 7/00

(52) U.S. Cl. CPC H02J 7/007; H02J 7/0052
USPC 320/157; 320/162; 320/160

(57) ABSTRACT

Disclosure has a method for charging a rechargeable battery. The rechargeable battery is charged by a charger in a first constant current mode for a main charge time period. After the main charge time period, the charger stops charging the rechargeable battery for a relaxation time period. During a sample time period that starts after a predetermined settle time period following the beginning of the relaxation time period, the charger detects an open-circuit voltage of the rechargeable battery to compare with a target voltage. If the open-circuit voltage is less than the target voltage, the charger charges the rechargeable battery in a second constant current mode for a coercive charge time period.

### CROSS-REFERENCE TO RELATED APPLICATION

This application claims priority to and the benefit of Taiwan Application Series Number 102127028 filed on Jul. 29, 2013, which is incorporated by reference in its entirety.

### BACKGROUND

The present disclosure relates generally to charging methods for rechargeable batteries.

Rechargeable batteries, capable of being recharged for repeated use, play an essential role in portable electronic devices which become more and more popular nowadays. To extent the time when a portable device is vital and workable, the rechargeable battery in it must be charged as full as possible. A rechargeable battery should not be over charged, nevertheless. An alkaline rechargeable battery, for example, will suffer in permanent damage if over charged with only several micro voltages beyond its full operation voltage.

FIG. 1 demonstrates a charger 10 and a rechargeable battery 20. V_{BAT} denotes the battery voltage across the rechargeable battery 20, and I_{CHG} the charging current from the charger 10 to the rechargeable battery 20. Shown in FIG. 1, rechargeable battery 20 is represented by an equivalent circuit consisting of internal resistor 26, capacitor 24, and main capacitor 22, where internal resistor 26 and capacitor 24 are connected in parallel and main capacitor 22 acts as a reservoir for storing charge. When the rechargeable battery 20 is connected to nothing or an open circuit, the charging current I_{CHG} is zero and the battery voltage V_{VAT} will stabilize eventually at the same level as the voltage across main capacitor 22, which is accordingly denoted by an open-circuit voltage V_{OCV}. In this specification, an open-circuit voltage V_{OCV} could also be the battery voltage V_{BAT} when the charging current I_{CHG} is zero. The open-circuit voltage V_{OCV}, in a way, corresponds to the amount of the charge stored in the main capacitor 22.

FIG. 2 shows signals generated during charging the rechargeable battery 20 in FIG. 1 according a conventional charging method. Shown in FIG. 2 are, from top to bottom, the battery voltage V_{BAT} and the open-circuit voltage V_{OCV}, the charging current I_{CHG}, and the saturation ratio of the rechargeable battery 20 in percentage. The method in FIG. 2 substantially charges the rechargeable battery 20 first in a constant current (CC) mode and then in a constant voltage (CV) mode. For the CC mode, the charging current I_{CHG} is a constant current I_{MJR} continuously charging the rechargeable battery 20, such that the battery voltage V_{BAT}, the open-circuit voltage V_{OCV}, and the saturation ratio all increase linearly. When the battery voltage

V_{BAT} is about a target voltage V_{TAR}, which roughly corresponds to a fully-charged battery, the CC mode ends and the CV mode follows. The charger 10 in the CV mode substantially fixes the battery voltage V_{BAT} at a voltage level of the target voltage V_{TAR}, so the charging current I_{CHG} diminish over time while the open-circuit voltage V_{OCV} approaches to the target voltage V_{TAR} and the saturation ratio steadily gets closer to 100%. The method in FIG. 2 results in the rechargeable battery 20 with an open-circuit voltage V_{OCV} that is very close to, but does not exceed, the target voltage V_{TAR}. The rechargeable battery 20 is almost fully-charged, accordingly.

The method in FIG. 2 has disadvantages, though. For example, in case that the internal resistor 26 has a very large resistance, the duration for the CV mode to fully charge the rechargeable battery will become very long or even impractical. One possible scenario could be that 20% of the overall charging time is spent for the CC mode to have a rechargeable battery reach its 50% charge capacity while 80% of the overall charging time is spent for the CV mode to provide the rest 50% of its total charge capacity.

Accordingly, it is always a demand in the art to shorten the overall charging time.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 demonstrates a charger and a rechargeable battery in the art;

FIG. 2 shows signals generated during charging the rechargeable battery in FIG. 1 according a conventional charging method;

FIG. 3 demonstrates a charger and a rechargeable battery according to embodiments of the invention;

FIG. 4 shows signals generated during charging the rechargeable battery in FIG. 3;

FIG. 5 details some signals during the supplemental time period T_{SUP}; and

FIGS. 6A and 6B show the charging current I_{CHG} in FIG. 4 according to two different embodiments.

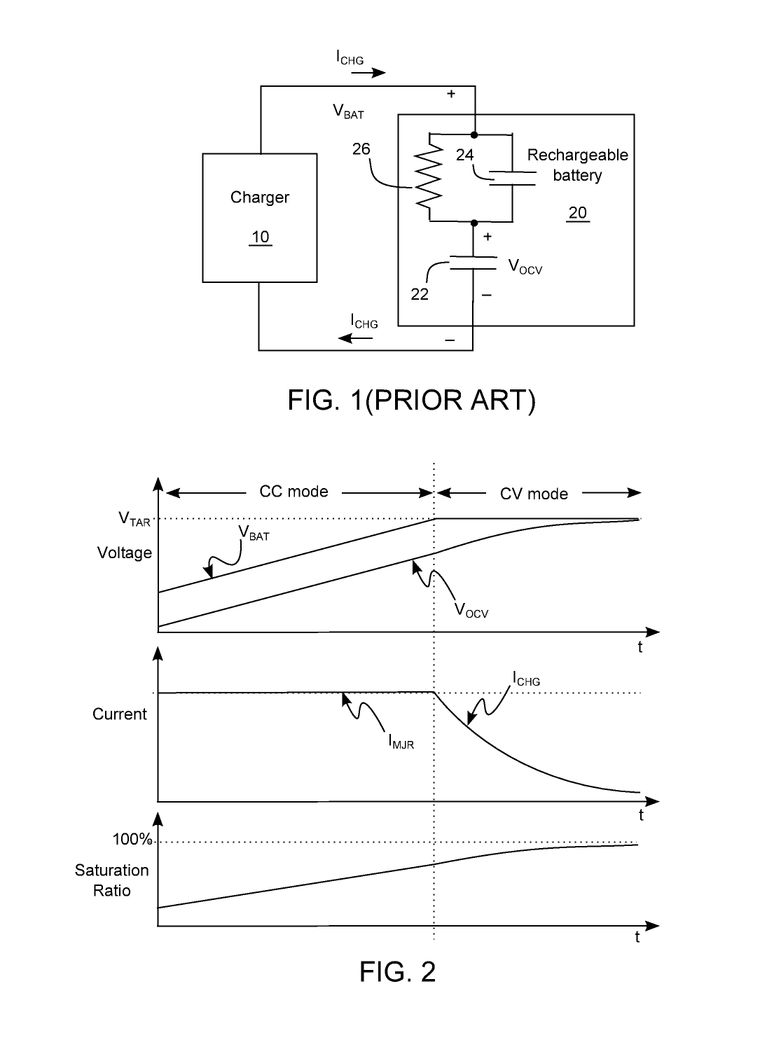

### DETAILED DESCRIPTION

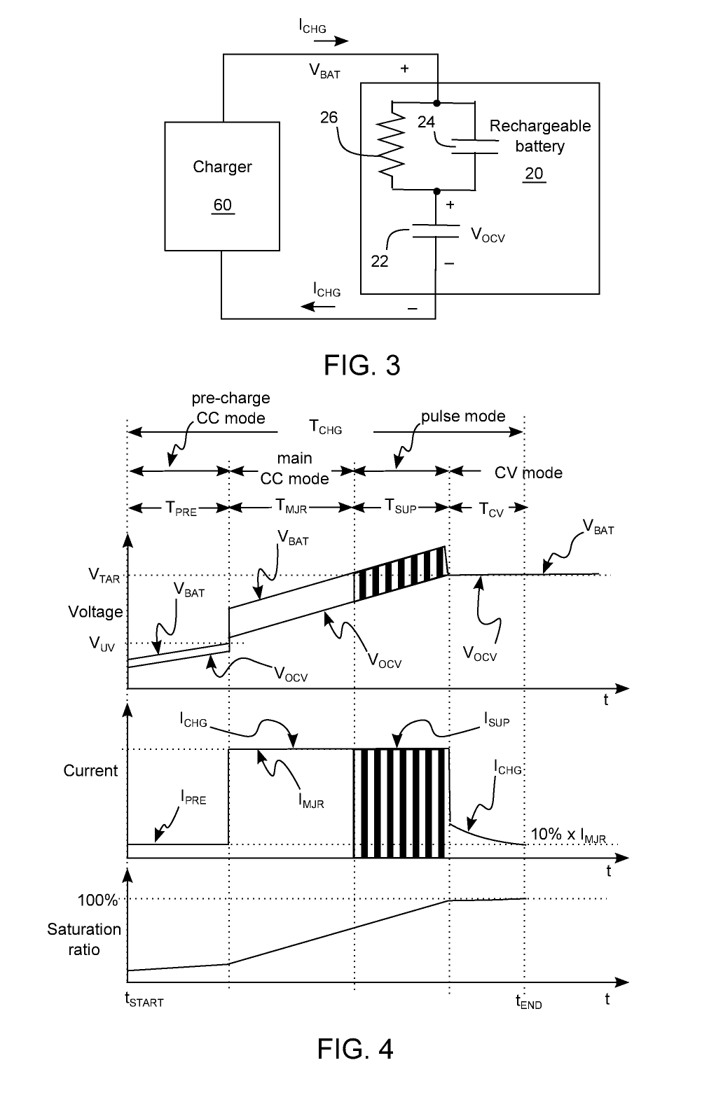

FIG. 3 demonstrates a charger 60 and a rechargeable battery 20 according to embodiments of the invention. FIG. 4 shows signals generated during charging the rechargeable battery 20 in FIG. 3. Similar to the signals in FIG. 2, FIG. 4 has, from top to bottom, the battery voltage V_{BAT} and the open-circuit voltage V_{OCV}, the charging current I_{CHG}, and the saturation ratio of the rechargeable battery 20 in percentage.

Shown in FIG. 4, the overall charging time T_{CHG} (from t_{START} to t_{END}) is divided into four time periods, including pre-charge time period T_{PRE}, main charge time period T_{MJR}, supplemental time period T_{SUP}, and constant voltage time period T_{CV}, sequentially.

In the beginning, the battery voltage V_{BAT} is less than an under voltage V_{UV}, and pre-charge time period I_{PRE} starts. During the pre-charge time period I_{PRE,} the rechargeable battery 20 is charged in a constant current mode, in which the charging current I_{CHG} is controlled to be a relatively small constant current I_{PRE}, as demonstrated in FIG. 4. The battery voltage V_{BAT} is monitored during the pre-charge time period I_{PRE}. Once the battery voltage V_{BAT} exceeds the under voltage V_{UV}, which is less than the target voltage V_{TAR}, the pre-charge time period I_{PRE} concludes and the main charge time period T_{MJR} begins .

During the main charge time period T_{MJR}, the rechargeable battery 20 is charged in another constant current mode, in which the charging current I_{CHG} is controlled to be a constant current I_{MJR} larger than the constant current I_{PRE}. In one embodiment, the constant current I_{MJR} is 10 times larger than the constant current I_{PRE}. The battery voltage V_{BAT} is also monitored during the main charge time period T_{MJR}, which concludes if the battery voltage V_{BAT} is found to exceed the target voltage V_{TAR}. The supplemental time period T_{SUP} follows the main charge time period T_{MJR}.

During the supplemental time period T_{SUP}, the rechargeable battery 20 is charged in a pulse mode, in which the charger 60 alternatively charges and stops charging the rechargeable battery 20. When the rechargeable battery 20 is charged, the charging current I_{CHG} is a supplemental constant current I_{SUP}, which optionally might become another constant current with a different value after a break of stopping charging. During the supplemental time period T_{SUP}, the charger 60 detects the open-circuit voltage V_{OCV}, which is the battery voltage V_{BAT} when the charging current I_{CHG} is zero. Once the open-circuit voltage V_{OCV} is equal to or exceeds the target voltage V_{TAR}, the supplemental time period T_{SUP} ends and the constant voltage time period I_{CV} follows. The operation during the supplemental time period T_{SUP} will be detailed soon.

During the constant voltage time period I_{CV}, the charger 60 substantially fixes the battery voltage V_{BAT} at a voltage level of the target voltage V_{TAR}, so as to continue charging the rechargeable battery 20. As the open-circuit voltage V_{OCV} has reached the target voltage V_{TAR} in the end of the supplemental time period T_{SUP}, the charging current I_{CHG} drops quickly, and the saturation ratio becomes very close to, if not equal to, 100%. In one embodiment, when the charging current I_{CHG} is less than 10% of the constant current I_{MJR}, as what is happening at time t_{END} in FIG. 4, the rechargeable battery 20 seems to be fully charged and the constant voltage time period I_{CV} ends. In this final end, the charger 60 is decoupled from the rechargeable battery 20, and the charging current I_{CHG} is kept as about 0.

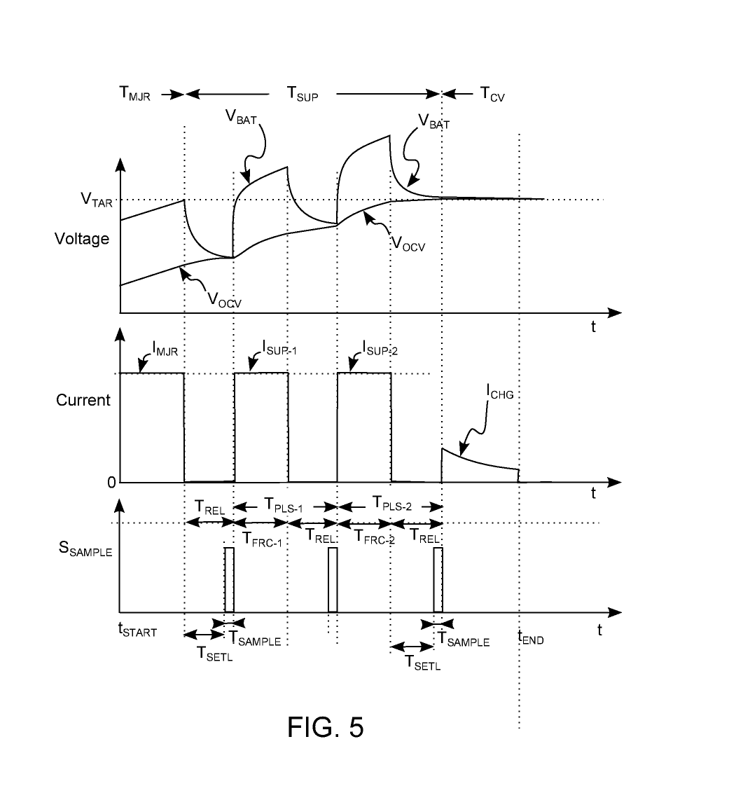

FIG. 5 details some signals during the supplemental time period T_{SUP}, including the battery voltage V_{BAT} and the open-circuit voltage V_{OCV}, the charging current I_{CHG}, and a sample signal S_{SAMPLE}. As demonstrated in FIG. 5, the main charge time period T_{MJR} ends and the supplemental time period T_{SUP} starts when the battery voltage V_{BAT} exceeds the target voltage V_{TAR}.

The supplemental time period T_{SUP} is composed of a relaxation time period T_{REL} and at least one pulse charge time period T_{PLS}. The supplemental time period T_{SUP} exemplified in FIG. 5 has a relaxation time period T_{REL} and two pulse charge time periods (T_{PLS-1} and T_{PLS-2}) each pulse charge time period including a coercive charge time period T_{FRC} and a relaxation time period T_{REL}.

During each coercive charge time period T_{FRC}, the charger 60 charges the rechargeable battery 20 in a constant current mode, using a supplemental constant current I_{SUP}. In FIG. 5, both the supplemental constant currents I_{SUP-1} and I_{SUP-2} respectively for the coercive charge time periods T_{FRC-1} and T_{FRC-2} have the same magnitude with the constant current I_{MJR}, but the invention is not limited to. In other embodiments of the invention, the supplemental constant current I_{SUP} might vary from one coercive charge time period to another. The duration of each coercive charge time period T_{FRC} is the same in FIG. 5, but the invention is not limited to. In one embodiment, for example, the later the coercive charge time period T_{FRC} the shorter the duration of the coercive charge time period T_{FRC}.

During each coercive charge time period T_{FRC}, the rechargeable battery 20 is forced to be charged, regardless the battery voltage V_{BAT}.

A relaxation time period T_{REL} follows the main charge time period T_{MJR} or a coercive charge time period T_{FRC}. During each relaxation time period T_{REL}, the charging current I_{CHG} is zero, the charger 60 presenting an open circuit to the rechargeable battery 20. Due to that the capacitor 24 discharges itself via the internal resistor 26, the open-circuit voltage V_{OCV} and the battery voltage V_{BAT} approach to each other over time. A sample time period T_{SAMPLE} starts a settle time period T_{SETL} after the beginning of a relaxation time period T_{REL}. Demonstrated in FIG. 5, as long as the settle time period T_{SETL} is long enough, the open-circuit voltage V_{OCV} and the battery voltage V_{BAT} are substantially the same. Accordingly, the charger 60 samples and detects the open-circuit voltage V_{OCV} during the sample time period T_{SAMPLE}. In FIG. 5, all settle time periods T_{SETL} have the same duration in length, but the invention is not limited to. In another embodiment, the later the relaxation time period T_{REL} the longer the settle time period T_{SETL} in it. A subsequent settle time period is longer than a previous settle time period for example.

During the sample time period T_{SAMPLE} in the pulse charge time period T_{PLS-2} in FIG. 5, the open-circuit voltage V_{OCV}, that is the battery voltage V_{BAT} when the charging current I_{CHG} has been zero for a settle time period T_{SETL}, exceeds the target voltage V_{TAR}. Accordingly, the supplemental time period T_{SUP} ends and the constant voltage time period I_{CV} follows.

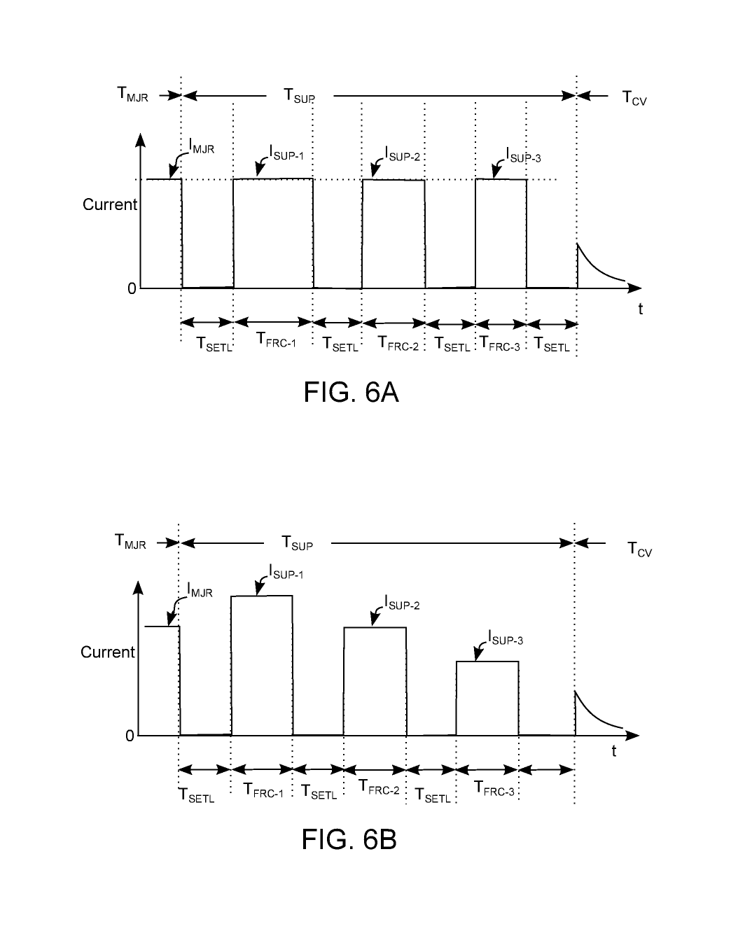

FIGS. 6A and 6B show the charging current I_{CHG} in FIG. 4 according to two different embodiments, during a supplemental time period T_{SUP}.

In FIG. 6A, the supplemental constant current I_{SUP} is the same for each coercive charge time period T_{FRC}, which nevertheless becomes shorter subsequently. For example, the open-circuit voltage V_{OCV} detected in the end of one relaxation time period T_{REL} is used in one embodiment to determine the duration of a subsequent coercive charge time period T_{FRC}, and the higher the open-circuit voltage V_{OCV} the shorter a subsequent coercive charge time period T_{FRC}. It is expected that the open-circuit voltage V_{OCV} ramps upward over time, so that for a coercive charge time period T_{FRC}, the later the shorter. Through this way, a rechargeable battery can easily avoid overcharge.

In FIG. 6B, each coercive charge time period T_{FRC} has the same duration, but the supplemental constant current I_{SUP} becomes less in a subsequent coercive charge time period. FIG. 6B shows that the supplemental constant current I_{SUP-1} is larger in magnitude than the constant current I_{MJR} used in the main charge time period T_{MJR}. For example, the open-circuit voltage V_{OCV} detected in the end of one relaxation time period T_{REL} is used in one embodiment to determine the magnitude of the supplemental constant current I_{SUP} in a subsequent coercive charge time period T_{FRC}, and the higher the open-circuit voltage V_{OCV} the less the supplemental constant current I_{SUP} in a following coercive charge time period. This way could also prevent a rechargeable battery from being over charged.

In another embodiment, the open-circuit voltage V_{OCV} detected in the end of one relaxation time period T_{REL} is used to determine both the duration of a subsequent coercive charge time period T_{FRC} and the magnitude of the supplemental constant current I_{SUP}.

In comparison with FIG. 2, FIG. 4 additionally has a supplemental time period T_{SUP} inserted between the main charge time period T_{MJR} and the constant voltage time period T_{CV}. With properly selected coercive charge time period T_{FRC} and supplemental constant current I_{SUP}, a rechargeable battery could be charged to its full capacity soon and avoid any overcharge, resulting in a shorter constant voltage time period T_{CV} in comparison with that in FIG. 2. The overall charge time T_{CHG}might become shorter in some embodiments of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for charging a rechargeable battery, comprising:
charging the rechargeable battery in a first constant current mode for a main charge time period;
after the main charge time period, stopping charging the rechargeable battery for a relaxation time period;
during a sample time period that starts after a predetermined settle time period following the beginning of the relaxation time period, detecting an open-circuit voltage of the rechargeable battery and comparing the open-circuit voltage with a target voltage; and
if the open-circuit voltage is less than the target voltage, charging the rechargeable battery in a second constant current mode for a coercive charge time period.

2. The method as claimed in claim 1, further comprising:
if the open-circuit voltage exceeds the target voltage, charging the rechargeable battery in a constant voltage mode;
wherein the constant voltage is about the same as the target voltage.

3. The method as claimed in claim 2, further comprising:
when the rechargeable battery is charged in the constant voltage mode, detecting a charging current flowing into the rechargeable battery; and
stopping charging the rechargeable battery if the charging current is less than a predetermined value.

4. The method as claimed in claim 1, wherein the second constant current mode uses a supplemental constant current to charge the rechargeable battery, the method comprises:
determining the supplemental constant current in response to the open-circuit voltage.

5. The method as claimed in claim 4, wherein the coercive charge time period is a predetermined constant.

6. The method as claimed in claim 1, wherein the second constant current mode uses a supplemental constant current to charge the rechargeable battery, the method comprises:
determining the coercive charge time period in response to the open-circuit voltage.

7. The method as claimed in claim 6, wherein the supplemental current is equal to the constant current for charging the rechargeable battery in the first constant current mode.

8. The method as claimed in claim 1, wherein the main charge time period ends when a battery voltage of the rechargeable battery exceeds a preliminary voltage.

9. The method as claimed in claim 8, wherein the preliminary voltage is equal to the target voltage.

10. The method as claimed in claim 8, further comprising:
prior to the main charge time period, charging the rechargeable battery in a pre-charge constant current mode for a pre-charge time period;
wherein the pre-charge time period ends when the battery voltage exceeds an under voltage which is less than the target voltage.

11. The method as claimed in claim 1, wherein after the coercive charge time period, the method repeats the step of stopping charging and the step of detecting and comparing.

12. A method capable for recharging a rechargeable battery, comprising:
charging the rechargeable battery in a pre-charge constant current mode, until a battery voltage of the rechargeable battery exceeds an under voltage;
after charging the rechargeable battery in the pre-charge constant current mode, charging the rechargeable battery in a first constant current mode until the rechargeable battery exceeds a target voltage, wherein the target voltage is higher than the under voltage;
after charging the rechargeable battery in the first constant current mode, stopping charging the rechargeable battery for a predetermined settle time period;
after the predetermined settle time period, detecting an open-circuit voltage of the rechargeable battery and comparing the open-circuit voltage with the target voltage; and
charging the rechargeable battery in a second constant current mode for a coercive charge time period, if the open-circuit voltage is less than the target voltage.

13. The method of claim 12, further comprising:
charging the rechargeable battery in a constant voltage mode, if the open-circuit voltage exceeds the target voltage.

14. The method of claim 12, further comprising:
determining the supplemental charge time period in response to the open-circuit voltage.

15. The method of claim 14, wherein the charging current used in the first constant current mode is the same as the charging current used in the second constant current mode.

16. The method of claim 12, further comprising:
determining the charging current to the rechargeable battery in the second constant current mode, in response to the open-circuit voltage.

17. The method of claim 16, wherein the coercive charge time period is a constant independent to the open-circuit voltage.

18. The method of claim 12, wherein the second constant current mode uses a supplemental constant current to charge the rechargeable battery, and the supplemental constant current is larger in magnitude than the charging current used in the first constant current mode.

19. The method of claim 12, wherein the charging current to the rechargeable battery in the pre-charge constant current mode is smaller than the charging current in the first constant current mode.

20. The method of claim 12, wherein the predetermined settle time period is a first settle time period, a second settle time period follows the coercive charge time period, and the second settle time period is longer than the first settle time period.
